(19) United States
(12) Patent Application Publication
(10) Pub. No.: US 2015/0286555 A1
(43) Pub. Date: Oct. 8, 2015

(54) SYSTEM AND METHOD FOR CONVERTING THE BUSINESS PROCESSES TO TEST-CENTRIC ACTIVITY DIAGRAMS

(71) Applicant: M/S. Cigniti Technologies Limited, Madhapur (IN)

(72) Inventor: Raja Sekhar Neravati, Hyperbad (IN)

(73) Assignee: M/S. Cigniti Technologies Limited, Madhapur (IN)

(21) Appl. No.: 14/680,132

(22) Filed: Apr. 7, 2015

Related U.S. Application Data
(60) Provisional application No. 61/976,522, filed on Apr. 8, 2014.

(51) Int. Cl. G06F 11/36

(52) U.S. Cl. CPC G06F 11/3684; G06F 11/3688

(57) ABSTRACT

A system and method for conversion of a business process to test-centric activity diagrams and to computationally generate automatic test suites for various quality attributes. It has been created to reduce the effort of a test engineer. The system consists of the processor, the parsing module, the analysis module and the test case generator. The method takes an activity diagram as the input, which can be generated using UML or any available standard business modelers and to be exported in the industry standard XMI format. The method is pro-agile as it achieves almost 100% functional coverage and has negligible dependence on conventional documentation. The method permits domain specialists and business analysts to add special, custom tags for specific validation conditions and functional checks.

### STATEMENT OF RELATED APPLICATIONS

This patent application is the non-provisional of and claims the benefit of U.S. Provisional Patent Application No. 61/976,522 having a filing date of 8 Apr. 2015.

### BACKGROUND OF THE INVENTION

1. Technical Field

The present invention describes a system and method for converting the business processes to test-centric activity diagrams to computationally generate automated test suites for various quality attributes.

2. Prior Art

Automated test scenario generation has always been a challenge, a problem that the software testing industry has been looking to solve. Conventionally, it has been proven that over 30% of the effort in a typical software test life cycle is spent in authoring and maintaining test cases. Reduction of this effort will have significant impact on the overall cost of the project and resource optimization.

The age-old Graph theory has been “re-purposed” to derive test sequences (paths) from the diagram and additional “In-house” methods have been used to generate additional test cases.

U.S. Pat. No. 8,479,164 titled “Automated Test execution plan generation” describes a method to automatically generate test execution plans. Using this test execution plan generation tool, a set of user- configured testing parameters for a software application under test can be obtained. Using the user-configured test parameters and a predefined test execution plan data model, a test execution plan can be automatically generated. This tool consists of a computer program product stored on a physical medium where the plurality of user-configured testing parameters correlates with, at least one of the items contained in a predefined test execution plan data model associated with this tool.

U.S. Pat. No. 6,378,088 titled “Automated test generator” describes a process where the test generator generates tests by randomly traversing a description of the interface of the program being tested. It consists of a computer and the test generator is executed by the computer. This represents an interface of the application program as a graph and it also automatically generates a test that exercises the application program. The tests generated contain randomly selected actions and randomly generated data. When these tests are executed, it randomly manipulates the program being tested.

U.S. Pat. No. 7,865,780 titled “Method for test case generation” describes a system, which provides randomly generated test cases for set of interfaces for a piece of software. The method comprises of a random test case number generator and a test case generator comprising of a parameter value generator. The parameter value generator assigns the parameter value for each interface based on the test case number. The method involves initializing a test case generator with parameter arrays with cardinality and a prime number for each individual parameter for each of the set of interfaces.

EP1926021 titled “Software test case generation” describes an apparatus, a computer program and a method for test case generation. The apparatus consists of a parser module, which analyses a source code into a code model, an analysis module, which utilizes the code model to parse a source code, in such a way that the execution paths can be determined. The system also consists of a user-interface module to visualize the possible execution paths in the source code and to allow the selection of the execution path from the user. A generation module is configured to generate a test case for testing of the selected execution path. These modules are configured to execute a computer program.

### BRIEF SUMMARY OF THE INVENTION

The present invention describes a system and a method for converting the business processes to test-centric activity diagrams to generate automated test suites for various quality attributes.

The method is based on a set of scientific, statistical and expert system based principles. The method is pro-agile with very less dependency on test documentation. This reduces the effort put in by a test engineer in arriving at test cases that measure the quality of the systems under test. Automated test suites generation is an effective method for testing. The test suites are generated by test-centric activity diagrams. The method takes an activity diagram as an input, which can either be generated using Unified Modeling Language (UML) or the requirements can be modeled by using any standard business modelers available, which is then exported in the industry standard Extensible Markup Language Metadata Interchange (XMI) file format. The method automatically generates test scenarios using this input. Since the generated test scenarios are mapped to the corresponding business processes, almost 100% of functional coverage can be achieved. The method also takes Path based, Expert System based, Exception based and Event based test conditions as inputs to the test generator for the production of automated test suites.

Test-centric activity diagrams are the graphical representations of workflows and business processes and is an effective method to generate test suites.

The method is useful to domain specialists and business analysts to add special custom tags for specific validation conditions and functional checks. The method is useful in addressing the faults such as wrongly initialized states, wrongly traversed conditions, unhandled errors, un-triggered events, which leads to different types of failures in the system.

The system for converting the business processes to test-centric activity diagrams to generate automated test suites consists of a processor to convert the business flows to the test centric activity diagram, a parsing module to parse the test centric activity diagram to produce nodes and edges, an analysis module to analyze the test centric activity diagram in terms of the nodes and edges by using different configurations and combination of test conditions and a test case generator to generate the test cases from test conditions through a graph theory and a custom method.

A complete understanding of the present invention may be obtained by reference to the accompanying drawings, when considered in conjunction with the subsequent, detailed description of preferred embodiments in which like elements and components bear the same designations and numbering throughout the figures.

### BRIEF DESCRIPTION OF THE DRAWINGS

FIG. 1 illustrates the system for generating the automated test suites.

FIG. 2 illustrates the overall conversion of business flows to test centric activity diagram and generation of automatic test suites.

FIG. 3a illustrates parsing activity diagram to produce nodes and edges.

FIG. 3b illustrates generation of different types of nodes and edges.

FIG. 4a illustrates flow of generating test cases using concurrent test conditions.

FIG. 4b illustrates flow of generating test cases using path or signal based test conditions.

FIG. 5 illustrates an example of “order processing” for generating the test cases using the present invention.

### DETAILED DESCRIPTION OF PREFERRED EMBODIMENTS

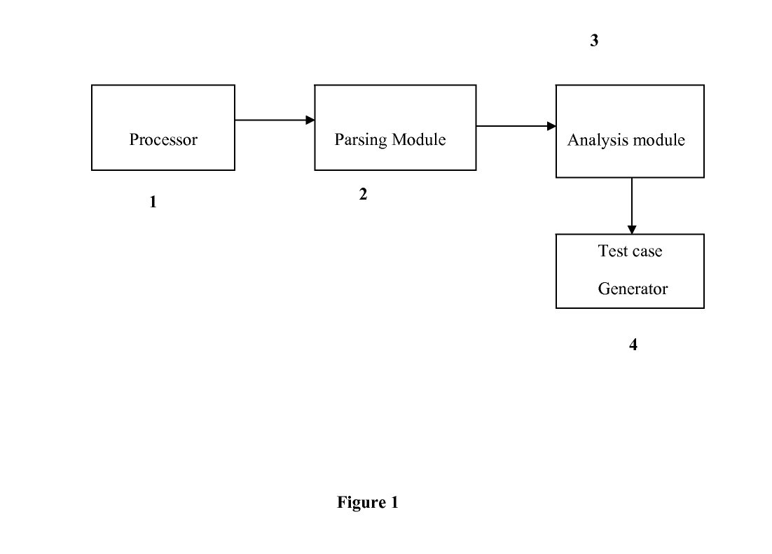

FIG. 1 illustrates the system for generating the automated test suites. The system comprises a processor 1, which is configured for converting business flows to test centric activity diagrams 5. A parsing module 2 is configured to parse the activity diagram to generate the nodes and edges 7. The parsing module 2 helps in parsing the test centric activity diagram 5 through the XMI file 23 to get the document object of the XMI file 24. The child elements are iterated 25 to check the action of node type and to get element name identity and tags information 27. An analysis module 3 is configured to analyze the converted test centric activity diagrams. The activity diagrams are analyzed in terms of nodes and edges 7 by using different configurations 8 and combination of test conditions 9, which includes path based test conditions 10, expert system based test conditions 11, exception or error based test conditions 12 and event based test conditions 13. The test case generator 4 is a programmatic way of generating the test cases based on series of test design techniques. The test case generator 4 generates test cases through the graph theory 15 and the custom method 16.

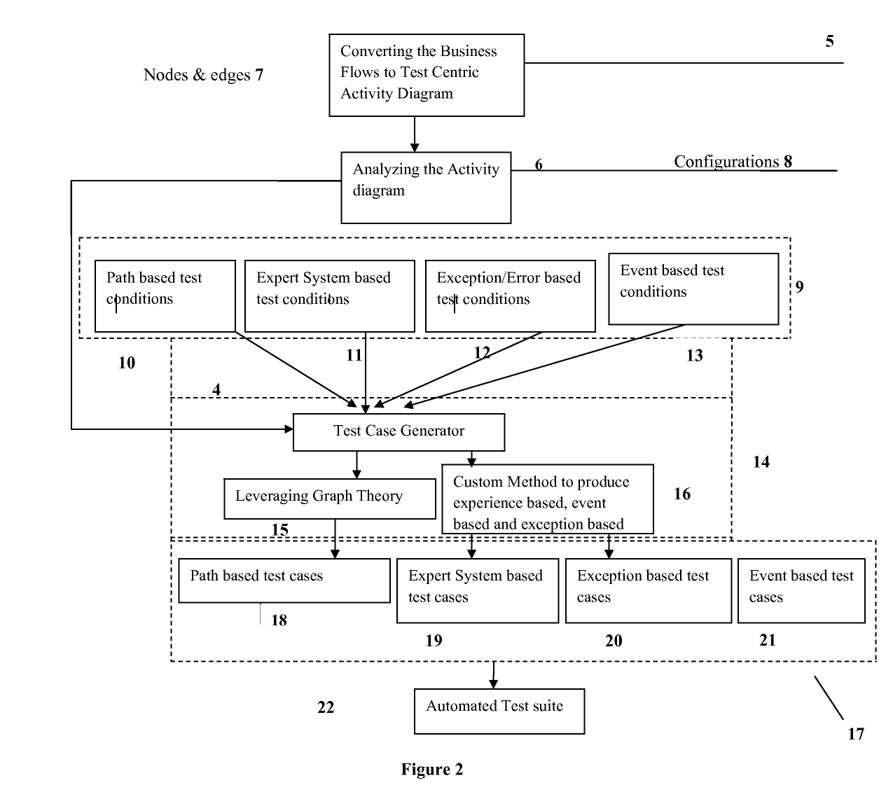

FIG. 2 illustrates the conversion of business flows to test centric activity diagram and generation of automatic test suites. The business flows are converted to test centric activity diagram 5. The test centric activity diagram is analyzed in terms of nodes and edges 7 by using different configurations 8 and combination of test conditions 9, which includes path based test conditions 10, expert system based test conditions 11, exception or error based test conditions 12 and event based test conditions 13 resulting in the test case generator 4. A node is also referred as a vertex and refers to an action or sub-action within an activity. An edge is a path or a link that connects two nodes. The test case generator 4 is a programmatic way of generating the test cases based on series of test design techniques. The test case generator 4 generates test cases through the graph theory 15 and the custom method 16. The combination 14 includes the test case generator 4, the graph theory 15 and the custom method 16. The graph theory 15 represents collection of all knowledge related to the mathematical structures used to represent an activity as a collection of nodes connected through edges. The custom method 16 is a knowledge system containing collection of methods from the graph theory 15 used to generate the test cases automatically. The test case generator 4 produces one or more test cases 17 including path based test case 18, expert system based test case 19, exception based test cases 20 and event based test case 21. From these test cases, the automated test suites 22 are generated.

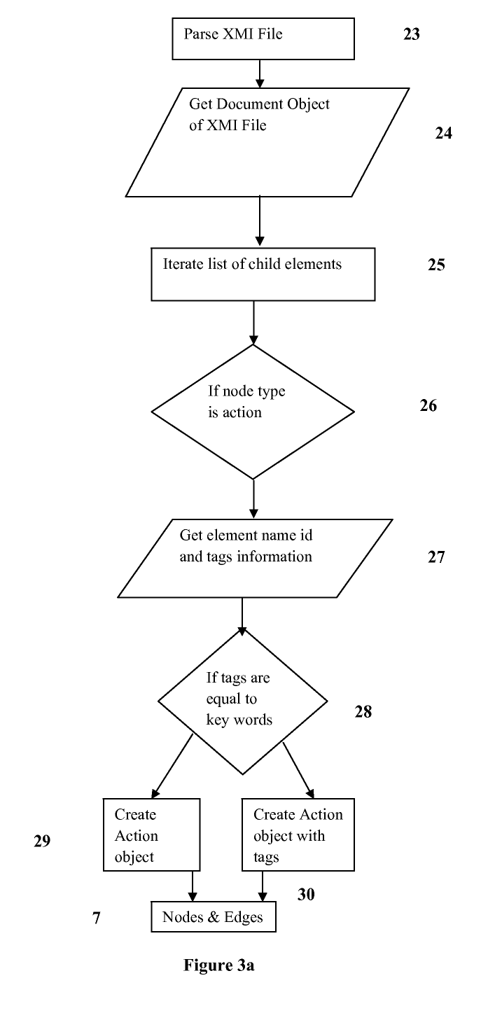

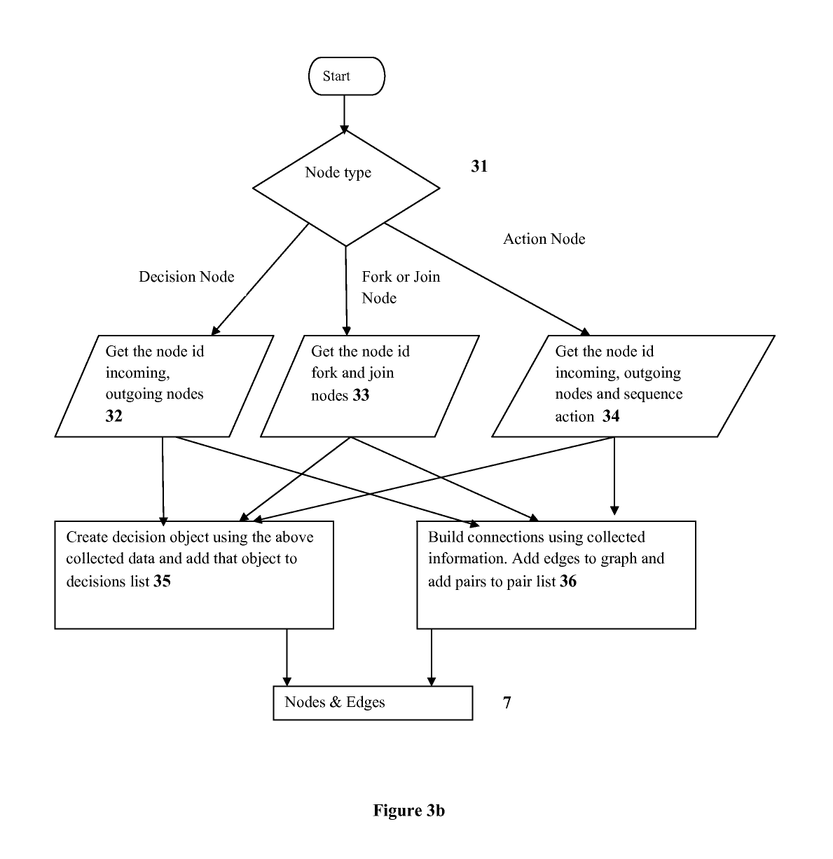

FIG. 3a illustrates parsing the activity diagram to produce nodes and edges. The centric activity diagram is parsed through a XMI file 23 to get the document object of XMI file 24. The child elements are iterated 25 to check the action of node type 26 and to get element name identity and tags information 27. The tags are checked for equality 28 with the key words and the action object without tags 29 and the action object with tags 30 are created to generate nodes and edges 7.

FIG. 3b illustrates the generation of different types of nodes and edges. For the node types 31, node identity (ID) is obtained for incoming and outgoing node called a decision node 32, for fork or join node 33 and for incoming, outgoing and sequence action node called as action node 34. The data is further collected and the object is added to a decisions list 35 to generate the nodes and edges 7. The edges are generated by building connections using the collected data and adding the edges to graph and pairs to the pair list 36.

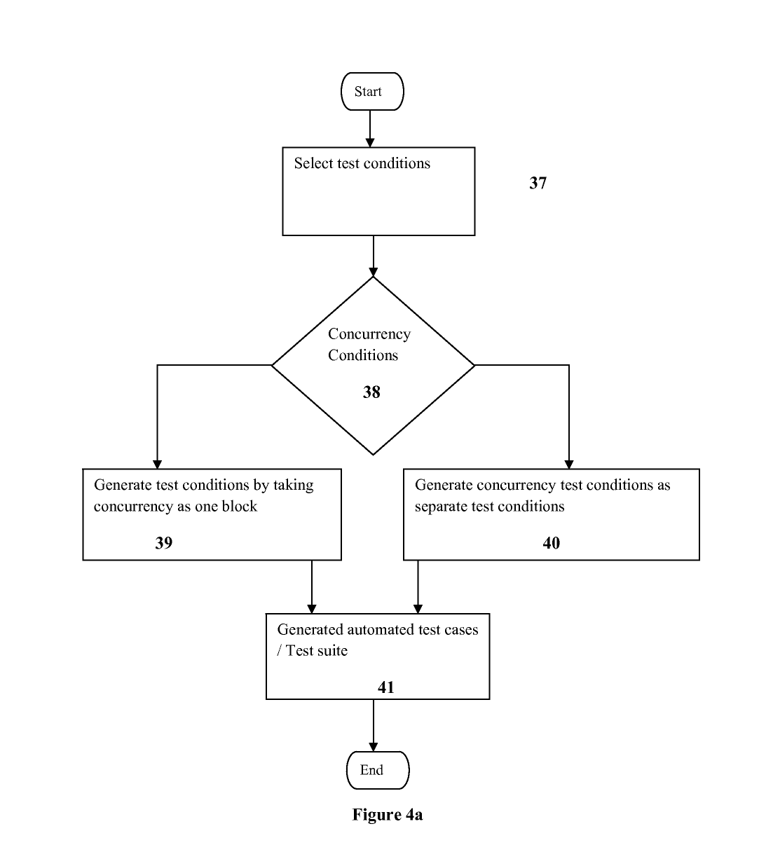

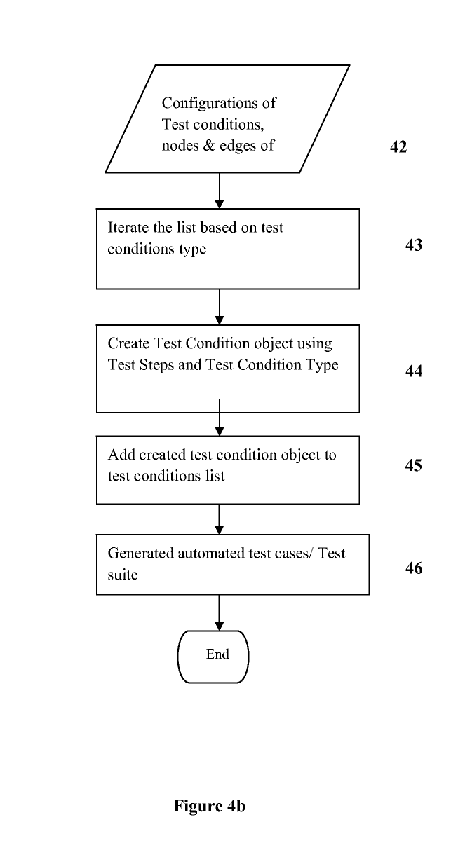

FIG. 4a illustrates flow of generating test cases using concurrent test conditions. The test case is generated by selecting the test conditions 37. The test conditions are parallel work items, which run either concurrently or sequentially. The test conditions 37 are converted to concurrency conditions 38, which are part of the test conditions. Further, the test condition is generated by either taking concurrency as one block 39 or concurrency test conditions are also generated as separate test conditions 40. Finally, automated test cases or test suites are generated 41.

FIG. 4b illustrates flow of generating test cases using path or signal based test conditions. The test conditions, nodes & edges of path based, signal based, and exception based test conditions are configured 42 and listed. The list is iterated based on the test conditions type 43. The test condition object is created using the test steps and test condition type 44. The created test condition object is added to the test conditions list 45 and the automated test cases or test suites are generated 46.

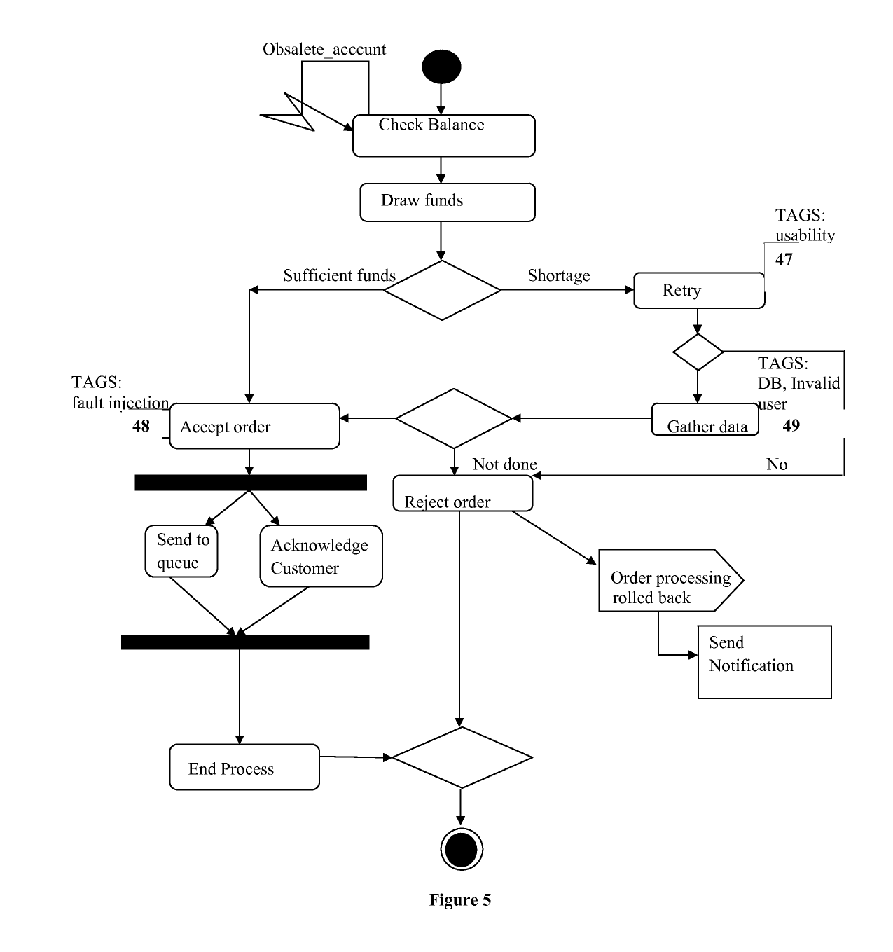

FIG. 5 illustrates an example of “order processing” for generating the test cases using the present invention. In this case, different types of test cases are generated namely exception-based test case, path-based test case, tag-based test case and event-based test case. The ‘order processing’ scenario includes the action types “check balance’, ‘draw funds’, ‘accept order’, ‘retry’, ‘gather data’, ‘reject order’ and ‘end process’. The tag ‘usability’ 47 is used for ‘retry’ action, the tag ‘fault injection’ 48 is used for ‘accept order’, the tags ‘database, invalid values’ 49 are used for the action ‘gather data’. The method resulted in generation of 10 test cases, which includes 4 path-based test cases, 4 tag-based or experience based test cases, 1 experience-based test case and 1 exception-based test case and 1 event-based test case.

The above detailed description of the embodiments, and the examples, are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. A system for conversion of one or more business flows to a test centric activity diagram and generation of one or more automatic test suites for one or more quality attributes based on a set of scientific, statistical and expert system based principles to reduce an effort in arriving at a test case that measures a quality of a system under test and to address one or more faults comprising (a) a processor 1, (b) a parsing module 2, (c) an analysis module 3, and (d) a test case generator 4, wherein:
a) the processor 1 converts one or more business flows to the test centric activity diagram;
b) the parsing module 2 parses the test centric activity diagram to produce one or more nodes and edges 7;
c) the analysis module 3 analyzes the test centric activity diagram in terms of the nodes and edges 7 by using one or more configurations 8 and combination of one or more test conditions 9 resulting in the test conditions; and
d) the test case generator 4 generates the test cases from the test conditions through a graph theory 15 and a custom method 16.

2. A method for converting one or more business flows to a test centric activity diagram and generation of one or more automatic test suites for one or more quality attributes based on a set of scientific, statistical and expert system based principles to reduce an effort in arriving at a test case that measures a quality of a system under test and to address one or more faults, comprising the steps of:
a) converting the one or more business flows to the test centric activity diagram 5 by a processor 1;
b) parsing the test centric activity diagram to produce one or more nodes and edges 7 by a parsing module 2;
c) analyzing the test centric activity diagram 6 in terms of the nodes and edges 7 by using one or more configurations 8 and combination of one or more test conditions 9 resulting in the test conditions by an analysis module 3;
d) generating the test cases from the test conditions by a test case generator 4 through a graph theory 15 and a custom method 16; and
e) generating one or more automated test suites 22 from the test cases 18.

3. The method as claimed in claim 2, wherein parsing the test centric activity diagram comprises the steps of:
a) parsing the test centric activity diagram through a Extensible Markup Language Metadata Interchange (XMI) file 23;
b) getting a document object of the XMI file 24;
c) iterating a list of one or more child elements 25;
d) getting an element identity and tagging information 27 if the node type is action 26;
e) checking if the tags are equal to key words 28 and:
i) creating an action object without the tags 29 if the tags are not equal; and
ii) creating the action object with the tags 30 if the tags are equal;
f) generating the nodes and edges 7.

4. The method as claimed in claim 2, wherein generation of the nodes and edges 7 comprises the steps of:
a) identifying a node type 31 and:
i) collecting the node identity for one or more incoming and outgoing nodes 32 if the identified node type is a decision node;
ii) collecting the node identity if the identified node type is a fork node 33;
iii) collecting the node identity if the identified node type is a join node 33; and
iv) collecting the node identity for incoming, outgoing and sequence nodes if the identified node type is an action node 34;
b) creating a decision object using the collected data and adding the object to a decision list 35;
c) building one or more collections using the collected data and adding the edges to a graph and one or more pairs to a pair list 36; and
d) generating the nodes and edges 7 from the decision list and the pair list.

5. The method as claimed in claim 2, wherein generating the test cases using one or more concurrency test conditions comprises the steps of:
a) selecting the test conditions 37;
b) converting the test conditions into the concurrency conditions 38;
c) generating the test conditions by considering the concurrency conditions as one block 39;
d) generating the concurrency test conditions as the separate test conditions 40; and
e) generating the automated test cases 41 from the test conditions.

6. The method as claimed in claim 2, wherein generating the test cases using one or more path and signal based test conditions comprises the steps of:
a) selecting a configuration of the test conditions, nodes and edges of path based, signal based and exception based test condition 42;
b) iterating the list based on type of the test conditions 43;
c) creating the test condition object using type of a test step and the test condition 44;
d) adding the created test condition object to the test condition list 45; and
e) generating the automated test cases from the test conditions 46.

7. The method as claimed in claim 2, wherein the test centric activity diagram is analyzed by using the test conditions including:
a) one or more path based test condition 10;
b) one or more expert system based test condition 11;
c) one or more exception and error based test condition 12; and
d) one or more event based test condition 13.

8. The method as claimed in claim 2, wherein the test cases include:
a) a path based test case 18;
b) an expert system based test case 19;
c) an exception based test case 20; and
d) an event based test case 21.
